(19) United States
(12) Patent Application Publication
(10) Pub. No.: US 2026/0300782 A1
(43) Pub. Date: Oct. 1, 2026

(54) AGENTIC META-ORCHESTRATOR FOR MULTI-TASK AI ASSISTANTS

(71) Applicant: Microsoft Technology Licensing, LLC, Redmond, WA (US)

(72) Inventors: Xiaofeng Zhu, Bothell, WA (US); Hemant Kumar, Redmond, WA (US); Yunshen Zhou, Bellevue, WA (US); Ichiro Ota, Redmond, WA (US); Venkatasatya Premnath Ayyalasomayajula, Sammamish, WA (US); Edward Onochie, Austin, TX (US); Ridip De, Seattle, WA (US); Linda Angelica Albarran, Mexico City (MX); Stephanie Marie Francoise Lucie Schuh, Carnation, WA (US); Issam Rashid, Sammamish, WA (US); Md Mamunul Islam, Snoqualmie, WA (US); Rishi Gupta, Woodinville, WA (US)

(21) Appl. No.: 19/092,853

(22) Filed: Mar. 27, 2025

(51) Int. Cl. G06N 5/043; G06N 5/01

(52) U.S. Cl. CPC G06N 5/043; G06N 5/01

(57) ABSTRACT

Example methods, apparatuses, and computer-readable media provide an artificial intelligence (AI) assistant utilizing a plurality of agents to answer a query. A host application receives the query from a client. The host application applies the query to an orchestrator to select a subset of agents to answer the query, the orchestrator applying a relevance ranking algorithm to the query and an agent description set including a description of each agent and a description of a separator class. The orchestrator may dynamically select a number of the agents in the subset based on a ranking of the separator class, which is associated with a description of context outside of a domain of the plurality of artificial intelligence agents. The host application provides the query to each selected agent in the subset of agents. The host application aggregates responses from each selected agent into a response to the client.

### BACKGROUND

Generative artificial intelligence (AI) has rapidly advanced and has shown promise in providing interactions between human users and computer systems. For example, chat bots are a form of generative AI that uses a large language model (LLM) to respond to prompts from a user. Such chat bots have been incorporated into various customer facing applications to provide services such as searching, instructions, troubleshooting, and navigation.

Chat bots conventionally use an LLM to produce textual responses. An LLM, however, may be limited by its training corpus and may be unable to provide answers requiring current information. Further, an LLM may hallucinate and provide an answer without a factual basis. Additionally, an LLM may not have access to private domains. The costs of training an LLM may prevent practical updates to address the above issues. For instance, while fine-tuning an LLM for a certain domain may improve quality of answers, the costs of training an LLM for a specific use case may render such an approach impractical.

Accordingly, there is a need for improvements to generative AI to address current information and domain-specific issues without incurring impractical training costs.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to an apparatus for answering a query with a plurality of artificial intelligence agents, including: one or more memories storing computer executable instructions; and one or more processors configured to execute the instructions to cause the apparatus to: receive the query from a client; apply the query to an orchestrator to select a subset of agents to answer the query, the orchestrator applying a relevance ranking algorithm to the query and an agent description set including a description of each agent and a description of a separator class having a description of context outside of a domain of the plurality of artificial intelligence agents; provide the query to each selected agent in the subset of agents; aggregate responses from each selected agent; and output the aggregated response to the client.

In some aspects, the techniques described herein relate to a method of answering a query with a plurality of artificial intelligence agents including: receiving the query from a client; applying the query to an orchestrator to select a subset of agents to answer the query, the orchestrator applying a relevance ranking algorithm to the query and an agent description set including a description of each agent and a description of a separator class having a description of context outside of a domain of the plurality of artificial intelligence agents; providing the query to each selected agent in the subset of agents; and aggregating responses from each selected agent; and output the aggregated response to the client.

In some aspects, the techniques described herein relate to a non-transitory computer-readable medium storing computer-executable code that when executed by a processor causes the processor to: receive a query from a client; apply the query to an orchestrator to select a subset of agents to answer the query, the orchestrator applying a relevance ranking algorithm to the query and an agent description set including a description of each of a plurality of artificial intelligence agents and a description of a separator class having a description of context outside of a domain of the plurality of artificial intelligence agents; provide the query to each selected agent in the subset of agents; aggregate responses from each selected agent; and output the aggregated response to the client.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram of an example of an architecture for a system to provide responses to prompts with a generative artificial intelligence (AI) and a plurality of agents, in accordance with aspects described herein.

FIG. 2 is a diagram of an example agentic orchestrator, in accordance with aspects described herein.

FIG. 3 is an example of a model including a shared foundation model and arms corresponding to agents, in accordance with aspects described herein.

FIG. 4 is a diagram of an example decision tree model, in accordance with aspects described herein.

FIG. 5 is a schematic diagram of an example of an apparatus (e.g., a computing device) for orchestrating AI agents to answer user prompts, in accordance with aspects described herein.

FIG. 6 illustrates an example of a user device presenting an AI assistant utilizing multiple AI agents, in accordance with aspects described herein.

FIG. 7 is a flow diagram of an example of a method for answering a query with a plurality of AI agents, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to use of agents with a generative artificial intelligence (AI) service. A generative AI service may interact with a client such as a user device. For example, the generative AI service may provide answers to queries submitted by a user. Generative AI may refer to various models that are trained to generate content in response to a prompt. A generative AI model is trained on a corpus of works and the model generates a similar work based on the prompt. For example, Large Language Model (LLM) is a term that refers to artificial intelligence or machine-learning models that can generate natural language texts from large amounts of data. Large language models use deep neural networks, such as transformers, to learn from billions or trillions of words, and to produce texts on any topic or domain. LLMs can also perform various natural language tasks, such as classification, summarization, translation, generation, and dialogue. A small language model may be similar to an LLM, but trained or pruned to focus on a particular task or domain. Accordingly, a small language model may produce similar results to an LLM using fewer computing resources. Additionally, generative AI models include text-to-image and text-to-video AI models. Further, generative AI models may include multi-modal models that receive different types of input such as text, audio, images, and/or video. As used herein, the term “prompt” refers to any input into a generative AI model without being limited to a particular modality.

Although generative AI has proved useful in many contexts, there are several known issues with generative AI. One issue is the concept of a hallucination, where a generative AI may generate a response that has no factual support. One cause of hallucinations is a time gap between training and inference. The corpus used to train models, especially LLMs, has a cut-off date because of the large costs of training the model. Accordingly, a generative AI often has difficulty answering prompts related to information after the cut-off date and may hallucinate to provide a response. As another example, relevant information for answering a prompt may be in a private domain that is not included in the corpus.

One approach to addressing weaknesses of LLMs is to make use of specialized agents. An agent may be a generative AI model that is trained to perform a more particular task than an LLM. For example, an agent may be trained to collect the most recent information for answering a prompt. As another example, an agent may be trained for accessing a private domain using additional safeguards for data privacy and compliance. Although agents can improve the performance of a generative AI, agents present their own issues. For instance, if training of an agent is fully integrated with training of the LLM, adding additional agents may require costly training. Further, careful selection of which agents to apply to a prompt is important for maintaining general applicability of an AI service.

In an aspect, the present disclosure provides an AI service including an orchestrator that selects a subset of agents to answer a query. The orchestrator uses a relevance ranking algorithm based on descriptions of the agents. The descriptions may include a textual description and examples. Additionally, a separator class has a description of context that is outside of a domain of the plurality of artificial intelligence agents. Agents that are ranked higher than the separator class can be selected to answer the query. Accordingly, the AI service allows addition of new agents without a need to completely retrain a base model. Further, the base model can be shared among the agents to provide query processing. In an aspect, the AI services aggregates responses from each selected agent into a response to the client. The aggregation may be based on a trained meta-learning decision tree model.

Implementations of the present disclosure may realize one or more of the following technical effects. Firstly, selection of multiple agents based on a relevance ranking algorithm applied to descriptions allows addition of new agents to an AI assistant without a need to retrain a large model each time an agent is added. Thus, computing resources, time, and energy can be saved, making the computing system (e.g., a cloud datacenter) operate more efficiently. Secondly, ordering of agents using a meta-learning decision tree model quantifies user feedback to train the decision tree model and continuously improves the responses provided by an AI assistant. That is, the interface between the user and the AI assistant is improved based on the feedback provided by the users. In another aspect, application of multiple agents to software code compliance issues identifies non-compliant code. Accordingly, the AI assistant can improves quality of software code and reduce time for proofreading and testing software code.

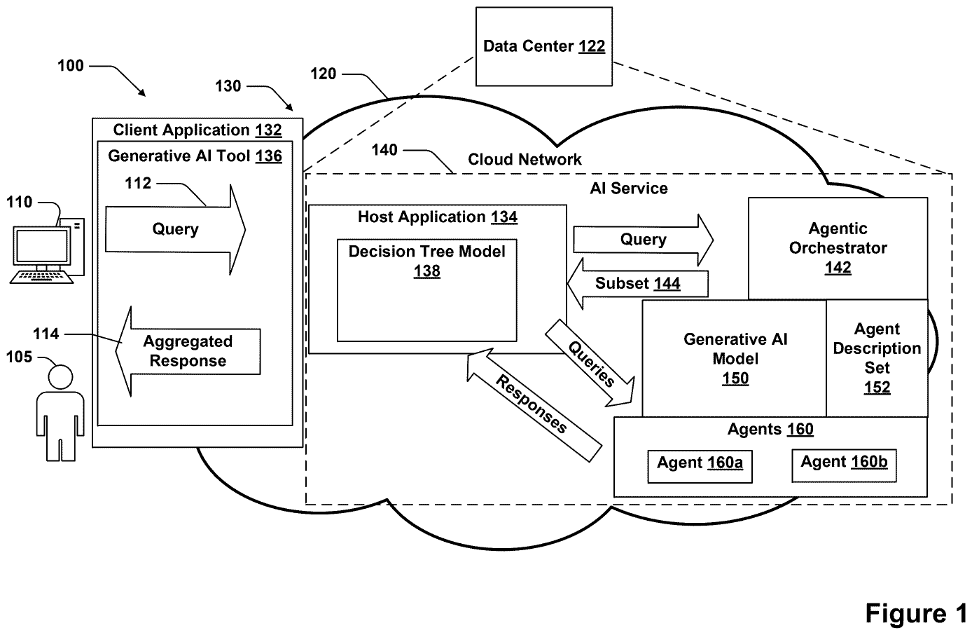

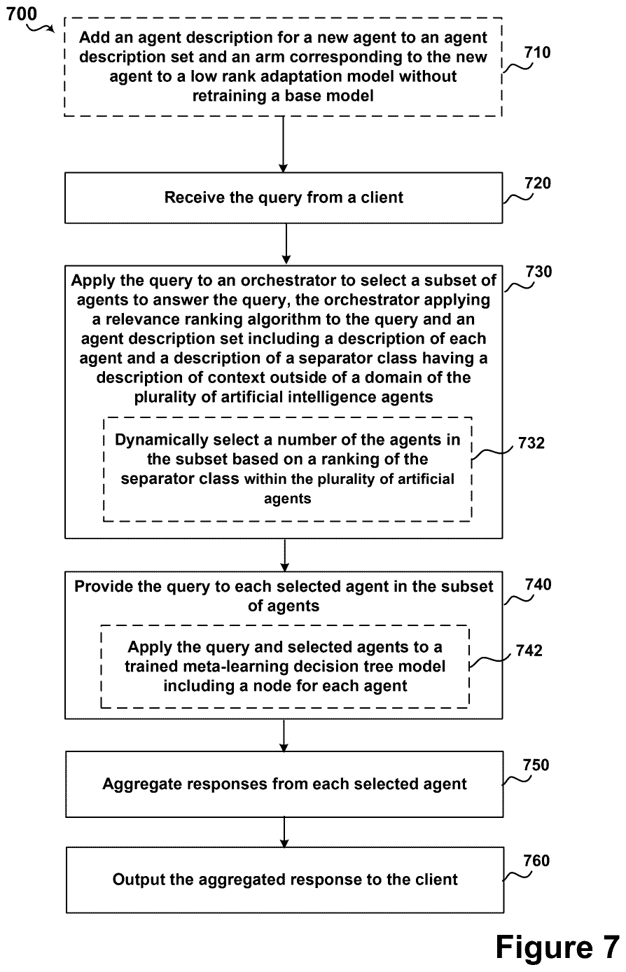

Turning now to FIGS. 1-7, examples are depicted with reference to one or more components and one or more methods that may perform the actions or operations described herein, where components and/or actions/operations in dashed line may be optional. Although the operations described below in FIG. 7 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a conceptual diagram 100 of an example of an architecture for a system 120 to provide responses to prompts with a generative artificial intelligence (AI) model 150 and a plurality of agents 160. The system 120 may be, for example, a cloud network including computing resources that are controlled by a network operator and accessible to public clients such as a user device 110 operated by a user 105. For example, the system 120 may include one or more datacenters 122 that include computing resources such as computer memory and processors. In some implementations, the datacenters 122 may host a compute service that provides computing nodes on computing resources located in the datacenter. The computing nodes may be containerized execution environments with allocated computing resources. For example, the computing nodes may be virtual machines (VMs), process-isolated containers, or kernel-isolated containers. The nodes may be instantiated at a datacenter 122 and imaged with software (e.g., operating system and applications for a service). The system 120 may include edge routers that connect the datacenters 122 to external networks such as internet service providers (ISPs) or other autonomous systems (ASes) that form the Internet.

In an aspect, the system 120 provides one or more hosted applications 130 supported by an AI service 140. For example, a hosted application 130 may include a client application 132 that executes on a user device 110 and a host application 134 that executes on the system 120. The client application 132 may operate independently on the user device 110, but some features may be available only through the system 120. In some implementations, the system 120 hosts the generative AI model 150 and provides access to the generative AI model 150 via the host application 134. For instance, the system 120 may provide a generative AI tool 136 within the client application 132. The generative AI tool 136 may be referred to as an AI assistant, Co-Pilot, or other name. In some implementations, the generative AI tool 136 may include an interface (e.g., basic text-based interface such as a chat interface). In an aspect, the present disclosure provides a hosted application 130 that can supplement a standard interface with additional interface components.

In an aspect, the AI service 140 includes the host application 134, an orchestrator 142, the generative AI model 150, and a plurality of agents. The AI service 140 may receive a first query 112 (e.g., a prompt) from the client application 132 or a user 105 thereof. For instance, the user may enter a query into an interface or select a query from a list of common questions to as the AI service 140. The host application 134 coordinates one or more models to provide an aggregated response 114 to the query 112. The host application 134 may provide the query 112 to an orchestrator 142 that is configured to select a subset of the agents 160 to answer the query. In some implementations, the orchestrator 142 utilizes a generative AI model 150 to apply a relevance ranking algorithm to the query and an agent description set 152 including a description of each of the agents 160. The description of each agent may include a textual description provided by a source of the agent (e.g., a programmer). In some implementations, the description also includes examples such as example queries and example answers. The orchestrator 142 returns a subset 144 of the agents 160. For example, the subset 144 may provide a top K set of agents 160, where K is dynamically determined based on the relevance of the descriptions in the agent description set 152, for example, with respect to a separator class. For instance, the subset 144 may include K agents ranked higher than the separator class.

The orchestrator 142 is configured to select a subset of agents to answer the query by applying a relevance ranking algorithm to the query 112 and an agent description set 152. The task of selecting agents becomes more complicated when agents can be added on-the-fly. For example, assuming that there are only three task-specific agents available to orchestrate user prompts to, training a multi-class text classification model is an intuitive approach. However, when there is a growing number of agents that are added to the AI service on a regular basis, it is unreasonable to have newly added agents wait until a new fine-tuned model that includes the new class is available to route user prompts to the new agents. Simple searching based on key words or sentence embeddings does not provide a relevant basis to choose the cut-off for the top-k value.

The orchestrator 142 can smoothly add new agents based on agent or class labels included in the agent description set 152. For example, partners of the AI service 140 can request on-boarding of new agents for handling tasks in private domains. For instance, partners of the AI service 140 may include software or services that execute in the system 120. The partners may share users 105 with the AI service 140. In some implementations, the client application 132 may be integrated into an application of a partner. Example, agents may perform tasks such as creating a new document specific for a software application, checking an order status, adding a user to a purchased subscription, etc.

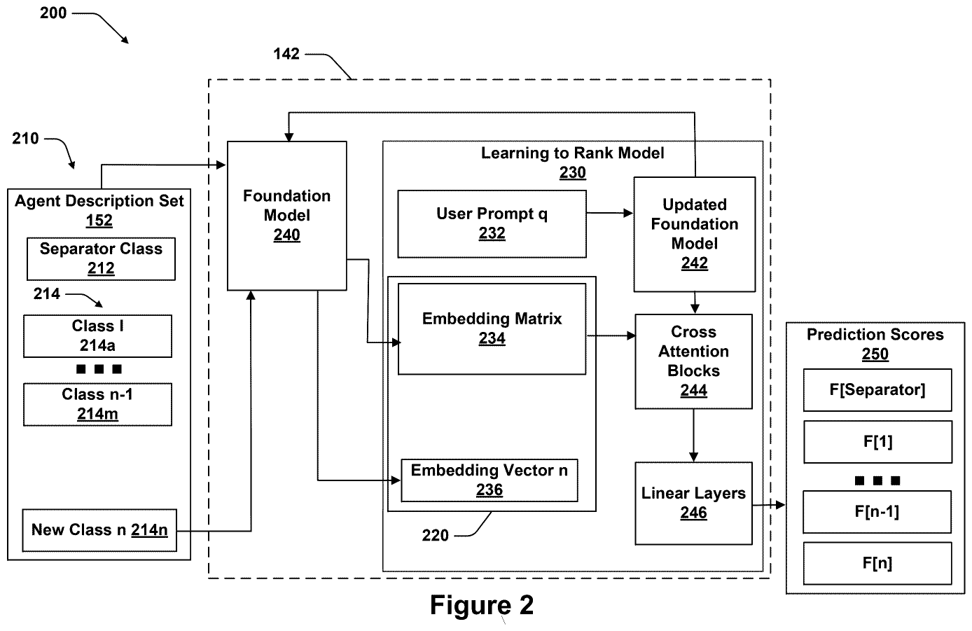

FIG. 2 is a diagram 200 of operation of an example agentic orchestrator 142. The diagram 200 illustrates offline conversion of agent descriptions 210 (generically referred to as a class) to semantic embeddings 220 (e.g., embedding matrix 234 and/or embedding vector 236). For example, the semantic embeddings 220 may be an embedding matrix that represents the agent description set 152. When a new agent description is added, the foundation model 240 to generate a new embedding vector 236. The agent descriptions 210 may be stored in the agent description set 210 and include a separator class 212 and agent classes 214. For instance, the agent classes 214 may include agent classes 214a-214n, where agent class 214n is a new class. As described below, the separator class 212 may be a description that separates relevant agents/classes from less relevant agents/classes. The separator class 212 can choose the top-k agents/classes based on user prompts. The separator class 212 indicates a class that is not defined in current categories, i.e., the separator class corresponds to a context outside of a domain of the agents 160. The learning-to-rank model 230 maps the separator class 212 to the top-k position, i.e., the separator class 212 itself and agents/classes that are ranked below this separator class 212 are not relevant to the user prompts.

The orchestrator uses the semantic embeddings 220 (e.g., embedding matrix 234 and embedding vector 236) to train a listwise multi-level learning-to-rank model 230. The model 230 targets higher relatedness prediction scores 250 for agents that are ranked higher than others. The user prompt (q) 232 and the agent description set 152 use the same foundation model 240 as an embedding model, which is generic. That is, the foundation model 240 produces the embedding vector 236 for each agent description 210 and the embedding matrix 234 for the user prompt 232. In an example implementation, BERT was used as the foundation model 240. The learning-to-rank model 230 with BERT as the foundation model 240 was more stable than using BERT soft-max classification trained for all classes. The learning-to-rank model 230 can maintain inference efficiency by caching the agent/class embeddings during training and inference. The user prompt 232 is input into the updated foundation model 242. The output from the updated foundation model 242 is provided to cross attention blocks 244 along with the embedding matrix 234. Then the output from the cross attention blocks 244 are input to linear layers 245, which generate prediction scores 250 for each class.

The learning to rank model 230 may utilize class hierarchies. The semantics of real-world agents carry hierarchies. For example, for an E-commercial assistant, the learning to rank model 230 detects the business intents of user prompts and only continues processing intents that are related to relevant products (e.g., available or from a partner). The learning to rank model 230 routes the prompts to the desired categories of products. In addition, high-level AI assistants generally have limited data access to private domains. For example, the client application 132 may process a user prompt such as “what is my NAME bank balance?” and calls the NAME bank app, and the bank app calls its agents to check the user's balance.

The learning to rank model 230 may overcome the limitations of the classical softmax multi-class text classification. The labels of a three-class classification model can be represented as [0, 1, 0]. When the fourth class comes in, the classification model needs to extend the labels to e.g., [0, 0, 1, 0]. Therefore, conventionally, a new classification model needs to be trained when a new class appears. Moreover, the 0-1 labeling system assumes that all classes are independent, which ignores the semantics of the class labels and the connections between the labels and the training texts. Such limitations impact the scalability of AI assistants when they continually onboard new agents. In contrast, the learning to rank model 230 can orchestrate a growing number of agents by utilizing agent/class descriptions. For example, an agent/class description may specify a function of the agent such as “ask for price.” The agent/class description may also include examples. For instance “ask for price” may include example queries such as “How much is . . . ?” or “What will . . . cost?” The agent/class descriptions act as the “candidates” during training of the learning-to-rank model 230 to select the top-k agents given a user prompt. The separator class has a description of context outside of a domain of the plurality of artificial intelligence agents. In some implementations, the separator class may be generated by an LLM with a query to define a domain that excludes the descriptions of the other classes. In some implementations, the separator class description may be provided by a programmer to limit a scope of the AI service 140. For instance, an E-commerce assistant may have a separator class defined to capture questions about products that are not available from an E-commerce provider. In some implementations, the description of the separator class may include examples that do not overlap with examples in the descriptions of the other agents. For instance, the examples may be drawn from public sources or queries to an LLM. Any examples that overlap between the separator class description and any description of an agent may be removed from the separator class description. All user prompts may share the same or different number of agent/class descriptions. A learning-to-rank model 230 can support this flexibility.

The learning-to-rank model 230 supports a multi-level rating. The agent ratings are defined by the hierarchical levels and relatedness to user prompts. For instance, a user prompt may be: “How much is Business Standard Annual Subscription for this product?” The ratings of agents such as “Ask for Price”, “business products”, “Separator Class”, “Compare Products”, “competitor products” are {2, 1, 0, −1, −2}, where the higher the positive rating the agent is more related to the user prompt, the lower the negative rating the agent is less related to the user prompt. The separator class 212 in this example uses “other business product matters” as the description of the separator class. For a different user prompt such as “What apps are included in this product, Business Standard subscription?” the ratings of agents “business products”, “Separator Class”, “Ask for Price”, “Compare Products”, “competitor products” are {2, 1, 0, 0, −1}. In yet another example, an irrelevant query such as “What will the weather be on Tuesday?” may produce ratings of agents “Separator Class”, “competitor products”, “Ask for Price”, “Compare Products” as {2, −1, −1, −2, −2}. That is, the separator class may be ranked highest because the query is unrelated to the other defined classes. If the separator class is ranked highest, the orchestrator 142 may return a response indicating that the query cannot be answered.

The learning-to-rank model 230 with multi-level rating can outperform text generation. LLM-based few-shot text classification can similarly classify text by adding labels. Though LLMs consider semantics of class labels, LLM generations can be more creative than needed in an assistant context, i.e., LLMs do not guarantee that the outputs contain the defined class labels. Moreover, due to the token limit for LLMs, an AI assistant may not feed enough few-shot examples into the prompt, leading to poor performance.

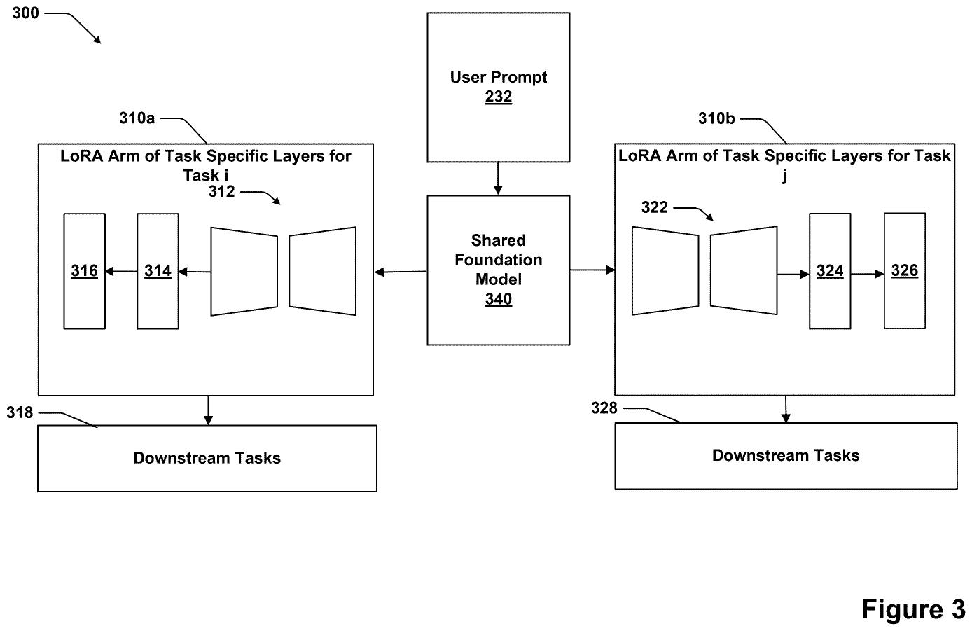

FIG. 3 is an example of a model 300 including a shared foundation model 340 and arms 310 corresponding agents. One major issue of leveraging multiple agents/models at the inference stage is memory consumption. Hosting a service with multiple LLMs fine-tuned from the same foundation model causes memory usage and waste. In an implementation, the learning to rank model 230 may be implemented as a low rank adaptation (LoRA) model. LoRA can provide memory optimization that subtracts the old LoRA weights and then adds the LoRA weights of the new task.

In an aspect, the generative AI model 150 can support multiple LoRA arms 310 at the same time during inference using the foundation model 340. In some implementations, the foundation model 340 can perform initial processing on the user prompt 232 (e.g., calculating embedding matrix 234). As discussed above with respect to FIG. 2, the learning to rank model 230 can then select the relevant agents. The agents may be implemented as LoRA arms 310. The arms 310 can share the same LLM memory as long as the compute resources allow.

The user prompts 232 and embedding matrix 234 are passed along to the LoRA arms 310, which can be sequential or asynchronous and parallel. Each LoRA arm 310 can implement a task. For example, core tasks in the E-commercial assistant include (implicit) product entity recognition in multi-turn messages of a chat conversation, determining price of identified products, comparing products, and identifying competitor products. Each of these tasks was trained and predicted using a LoRA arm. For example, a first LoRA arm 310 can include a transformer 312, listwise comparison layers 314, and retrieval augmented generation (RAG) layers 316. For instance, the first LoRa arm 310 may generate a ranking according to price. The output of the first LoRA arm 310 can be used as input to downstream tasks 318 (e.g., list formatting). The second LoRA arm 310b may include a transformer 322, product recognition layers 324, and token generation layers 326. For example, the second LoRA arm 310b may generate descriptions of products. The output of the first LoRA arm 310 can be used as input to downstream tasks 328 such as additional agents, which may be implemented as separate LoRA arms.

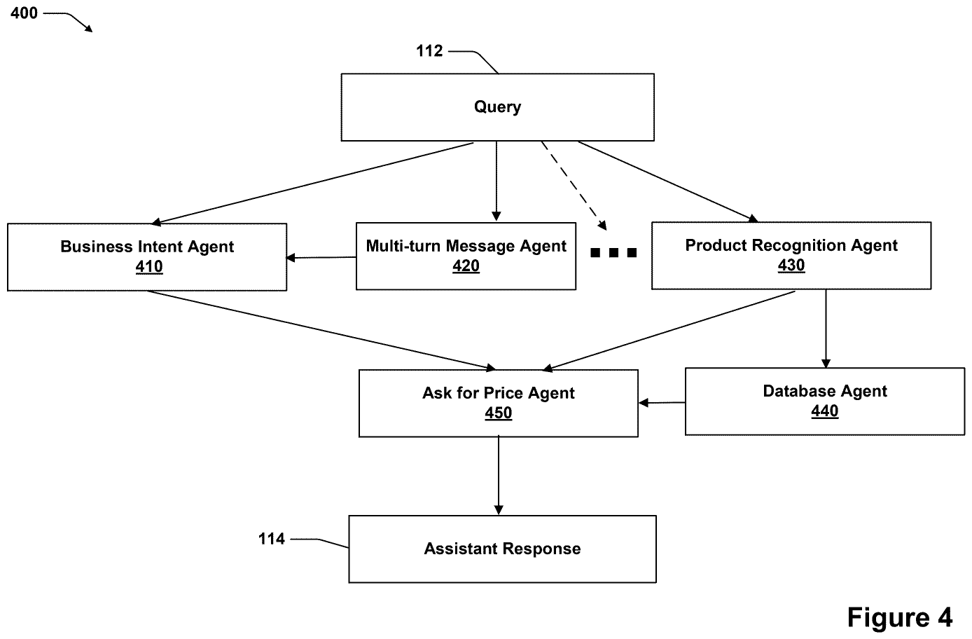

FIG. 4 is a diagram of an example decision tree model 400. For example, the decision tree model 40 may be an example of the decision tree model 138 that is trained to select an order to inference a selected subset of agents. The decision tree model 400 may order the selected agents and select the input for each agent. Instead of responding solely to cognitive heuristics, the decision tree model 400 may be a meta-learning decision tree model to decide on the best inference planning for user prompts. Training inputs are user prompts, their end-to-end copilot responses, and various models for agent-specific tasks. The inference planning includes the combination and ordering of agents (e.g. only using Phi-3.5 or going through product recognition agent, database agents, etc.)

Each node in the decision tree model 400 is an AI language agent that the orchestrator 142 assigns to the current user prompt to complete certain tasks. Each node can be implemented using a task-specific LoRA arm. For instance, the decision tree model 400 may represent an order selected for the E-commercial assistant. The query 112 may be a request to suggest a product with a pricing option based on user needs. The query 112 may be received in a single request, or via multiple messages in a chat interface.

As discussed above with respect to FIG. 2, the host application 134 provides the query 112 to the agentic orchestrator 142, which returns the subset 144 of the relevant agents. For example, the relevant agents may include a business intent agent 410, a multi-turn message agent 420, a product recognition agent 430, an ask for price agent 440, and a database agent 450. The decision tree model 400 may be trained to order the agents and combine the results to provide the aggregated response 114. For example, the decision tree model 400 may use feedback from users that rates aggregated responses 114. The decision tree model may be trained by adjusting weights to improve the ratings.

In the illustrated example, the query 112 may be provided to the business intent agent 410, the multi-turn message agent 420, and the product recognition agent. The multi-turn message agent 420 may be configured to collect contextual customer information from multiple message (e.g., a chat interface and/or website interactions). The multi-turn message agent 420 may provide the contextual customer information to the business intent agent 410. The business intent agent 410 may be configured to identify an intent of the query 112 (e.g., user prompt 232), for example, based on any context customer information. The product recognition agent 430 may be configured to identify products related to the query. For example, the product recognition agent 430 may identify product names and/or descriptions included in the query 112. The product recognition agent 430 may provide the product names and/or descriptions to a database agent 440 to retrieve additional information associated with the product names and/or descriptions. The business intent agent 410, product recognition agent 430, and database agent 440 may provide results to the ask for price agent 450. The ask for price agent 450 may associate a price with the identified products. One of the agents (e.g., the ask for price agent 450 or another agent selected as the last agent) may then aggregate the results, for example, to generate an answer to the business intent using the product information. The decision tree model 400 may output the aggregated response 114.

In another example, the AI service 140 may provide a code compliance assistant configured to evaluate whether a piece of code is compliant with a coded character set regulation. For example, GB 18030 is a coded character set regulation for coding Chinese characters (e.g., for correct display). The code compliance assistant may evaluate pull requests for software code to ensure compliance with the coded character set regulation. For instance, the code compliance assistant may scan every pull request of internal corporate service code during development operations to make sure the code changes are compliant. In addition to known code compliance issues, the code compliance assistant can keep monitoring and identifying new undiscovered code compliance issues. The code compliance assistant can be implemented using hierarchical agents. For example, top level agents may include an agent configured to identify a known compliance issue with the coded character set regulation; an agent configured to identify a known compliance issue outside of the coded character set regulation; an agent configured to identify a coded character display issue; or an agent configured to identify a coded character encoding issue. Each top-level agent may include sub-agents, each associated with a separate description of a specific issue to identify. Additional sub-agents may be added to the agent description set 152 as new issues are discovered.

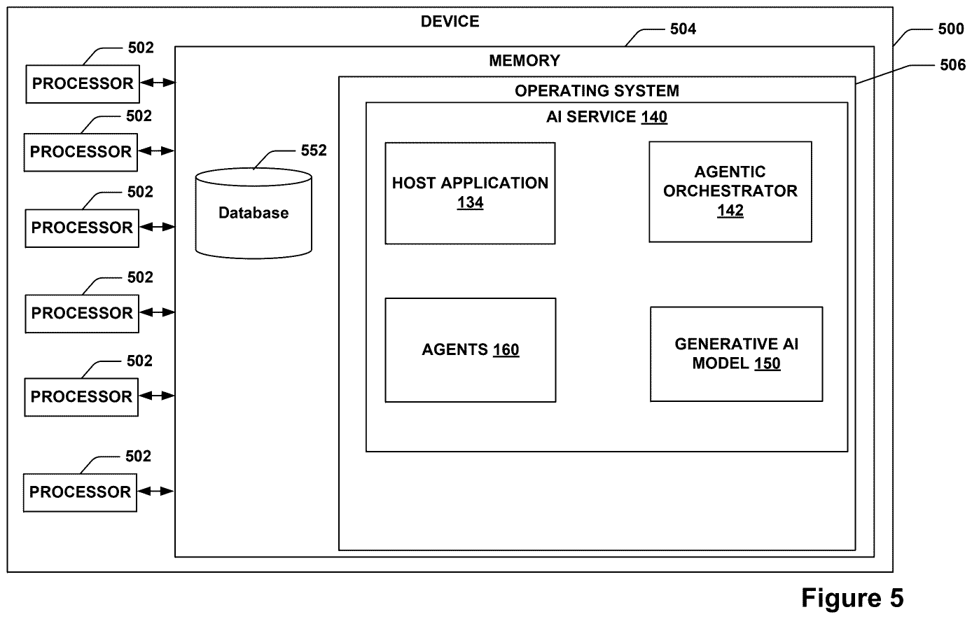

FIG. 5 is a schematic diagram of an example of an apparatus 500 (e.g., a computing device) for orchestrating AI agents to answer user prompts. The apparatus 500 may be implemented as one or more computing devices in the system 120.

In an example, the apparatus 500 includes at least one processor 502 and a memory 504 configured to execute or store instructions or other parameters related to providing an operating system 506, which can execute one or more applications or processes, such as, but not limited to, the AI service 140. For example, processors 502 and memory 504 may be separate components communicatively coupled by a bus (e.g., on a motherboard or other portion of a computing device, on an integrated circuit, such as a system on a chip (SoC), etc.), components integrated within one another (e.g., a processor 502 can include the memory 504 as an on-board component), and/or the like. Memory 504 may store instructions, parameters, data structures, etc. for use/execution by processor 502 to perform functions described herein. In some implementations, the memory 504 includes the database 552 for use by the AI service 140. In some implementations, the apparatus 500 includes the generative AI model 150, for example, as another application executing on the processors 502. Alternatively, the generative AI model 150 may be executed on a different device that may be accessed via an API 550.

In an example, the AI service 140 includes the host application 134, the agentic orchestrator 142, the generative AI model 150, and the agents 160.

In some implementations, the apparatus 500 is implemented as a distributed processing system, for example, with multiple processors 502 and memories 504 distributed across physical systems such as servers, virtual machines, or datacenters 122. For example, one or more of the components of the workflow automation application 130 may be implemented as services executing at different datacenters 122. The services may communicate via an API.

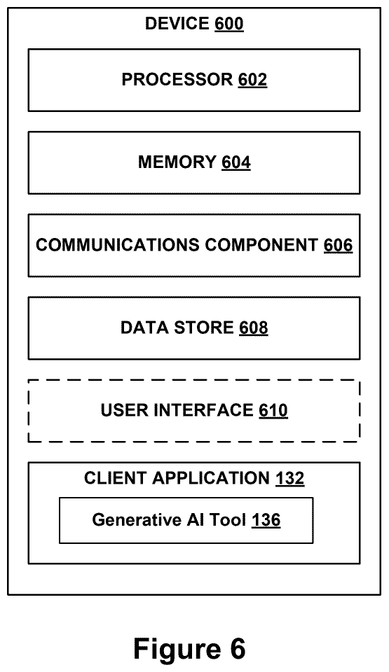

FIG. 6 illustrates an example of a user device 600. The user device 600 may be an example of the user device 110. In one aspect, device 600 includes processor 602, which may be similar to processor 502 for carrying out processing functions associated with one or more of components and functions described herein. Processor 602 can include a single or multiple set of processors or multi-core processors. Moreover, processor 602 can be implemented as an integrated processing system and/or a distributed processing system.

Device 600 further includes memory 604, which may be similar to memory 504 such as for storing local versions of operating systems (or components thereof) and/or applications being executed by processor 602, such as the client application 132 including the generative AI tool 136. Memory 604 can include a type of memory usable by a computer, such as random access memory (RAM), read only memory (ROM), tapes, magnetic discs, optical discs, volatile memory, non-volatile memory, and any combination thereof. The processor 602 may execute instructions stored on the memory 604 to cause the device 600 to perform the methods discussed below with respect to FIG. 7.

Further, device 600 includes a communications component 606 that provides for establishing and maintaining communications with one or more other devices, parties, entities, etc. utilizing hardware, software, and services as described herein. Communications component 606 carries communications between components on device 600, as well as between device 600 and external devices, such as devices located across a communications network and/or devices serially or locally connected to device 600. For example, communications component 606 may include one or more buses, and may further include transmit chain components and receive chain components associated with a wireless or wired transmitter and receiver, respectively, operable for interfacing with external devices.

Additionally, device 600 may include a data store 608, which can be any suitable combination of hardware and/or software, that provides for mass storage of information, databases, and programs employed in connection with aspects described herein. For example, data store 608 may be or may include a data repository for operating systems (or components thereof), applications, related parameters, etc. not currently being executed by processor 602. In addition, data store 608 may be a data repository for the client application 132.

Device 600 may optionally include a user interface component 610 operable to receive inputs from a user of device 600 and further operable to generate outputs for presentation to the user. One or more input devices may control the device 600 via the user interface component 610. Example input devices, may include but are not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, the device 600 may output data or signals via user interface component 610 to one or more output devices, including but not limited to a display, a speaker, a haptic feedback mechanism, a printer, any other mechanism capable of presenting an output to a user, or any combination thereof.

Device 600 additionally includes the client application 132 including the generative AI tool 136 for providing generative AI assistance to a user of the client application 132.

FIG. 7 is a flow diagram of an example of a method 700 for answering a query with a plurality of artificial intelligence agents. For example, the method 700 can be performed by the system 120, the apparatus 500 and/or one or more components thereof to answer a query 112 from a client (e.g., user device 110) using a plurality of agents 160.

At block 710, the method 700 may optionally include adding an agent description for a new agent to an agent description set and adding an arm corresponding to the new agent to a low rank adaptation model without retraining a base model. For example, in an aspect, apparatus 500, processor 502, memory 504, and/or orchestrator 142 may be configured to or may comprise means for adding an agent description for a new agent to an agent description set and add an arm corresponding to the new agent to a low rank adaptation model without retraining a base model. For example, the orchestrator 142 may add a new class 214n to the agent description set 152 and add an arm 310 to the model 300 without retraining the shared foundation model 240.

At block 720, the method 700 includes receiving the query from a client. For example, in an aspect, apparatus 500, processor 502, memory 504, and/or host application 134 may be configured to or may comprise means for receiving the query 112 from the client (e.g., user device 110). For example, the host application 134 may receive the query 112 from an application (e.g., client application 132) or a user 105 thereof to the AI service 140.

At block 730, the method 700 includes applying the query to an orchestrator to select a subset of agents to answer the query, the orchestrator applying a relevance ranking algorithm to the query and an agent description set including a description of each agent and a description of a separator class. For example, in an aspect, apparatus 500, processor 502, memory 504, and/or the orchestrator 142 may be configured to or may comprise means for applying the query 112 to an orchestrator 142 to select a subset 144 of agents to answer the query. The orchestrator 142 applies a relevance ranking algorithm (e.g., learning to rank model 230) to the query 112 and the agent description set 152 including a description of each agent (i.e. class 214) and a description of a separator class 212. In some implementations, the relevance ranking algorithm is a low rank adaptation model comprising a base model (e.g., foundation model 240) and an arm 310 corresponding to each agent 160. The base model is configured to generate an embedding matrix 234 of the query 112 (e.g., user prompt 232). In some implementations, at sub-block 732, the orchestrator 142 dynamically selects a number of the agents in the subset 144 based on a ranking of the separator class 212 within the plurality of artificial agents. The separator class 212 is associated with a description that is not defined by other descriptions in the agent description set 152. For example, the description of the separator class 212 may include examples that do not overlap with examples in the descriptions of the other agents.

At block 740, the method 700 includes providing the query to each selected agent in the subset of agents. For example, in an aspect, apparatus 500, processor 502, memory 504, and/or the host application 134 may be configured to or may comprise means for providing the query 112 to each selected agent 160 in the subset 144 of agents. In some implementations, the host application includes a trained meta-learning decision tree model 138. The block 740 may optionally include, at sub-block 742, applying the query and selected agents to the trained meta-learning decision tree model 138 including a node for each agent. The host application 134 uses the trained meta-learning decision tree model 138 to select a path through the nodes. The path may execute the agents corresponding to the nodes in parallel, asynchronously, and/or sequentially. For instance, the output of one node may be used as input to another node.

At block 750, the method 700 includes aggregating responses from each selected agent. For example, in an aspect, apparatus 500, processor 502, memory 504, and/or the host application 134 may be configured to or may comprise means for aggregating responses from each selected agent 160 into a response 114.

At block 760, the method 700 includes outputting the aggregated response to the client. For example, in an aspect, apparatus 500, processor 502, memory 504, and/or the host application 134 may be configured to or may comprise means for outputting the aggregated response 114 to the client (e.g., user device 110).

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media. Non-transitory computer-readable media excludes transitory signals.

The following numbered clauses provide an overview of aspects of the present disclosure:

Clause 1. An apparatus for answering a query with a plurality of artificial intelligence agents, comprising: one or more memories storing computer executable instructions; and one or more processors configured to execute the instructions to cause the apparatus to: receive the query from a client; apply the query to an orchestrator to select a subset of agents to answer the query, the orchestrator applying a relevance ranking algorithm to the query and an agent description set including a description of each agent and a description of a separator class having a description of context outside of a domain of the plurality of artificial intelligence agents; provide the query to each selected agent in the subset of agents; aggregate responses from each selected agent; and output the aggregated response to the client.

Clause 2. The apparatus of clause 1, wherein the orchestrator dynamically selects a number of the agents in the subset based on a ranking of the separator class within the plurality of artificial agents, wherein the separator class is associated with a description including examples that do not overlap with examples in the descriptions of the other agents in the agent description set.

Clause 3. The apparatus of clause 1 or 2, wherein the relevance ranking algorithm is a low rank adaptation model comprising a base model and an arm corresponding to each agent.

Clause 4. The apparatus of clause 3, wherein the base model is configured to generate an embedding matrix of the query.

Clause 5. The apparatus of clause 3, wherein the one or more processors are configured to execute the instructions to add an agent description for a new agent to the agent description set and add an arm corresponding to the new agent to the low rank adaptation model without retraining the base model.

Clause 6. The apparatus of any of clauses 1-5, wherein to provide the query to each selected agent, the one or more processors are configured to apply the query and selected agents to a trained meta-learning decision tree model including a node for each agent.

Clause 7. The apparatus of clause 6, wherein the trained meta-learning decision tree model is trained on user prompts, end-to-end responses, and models for agent-specific tasks to select an order to inference the selected subset of agents.

Clause 8. The apparatus of any of clauses 1-7, wherein the orchestrator is configured to receive a query including contextual customer information and the agents include one or more of: a business intent agent configured to identify an intent of the query; a multi-turn message agent configured to collect the contextual customer information from multiple messages; a product recognition agent configured to identify products related to the query; a pricing agent configured to obtain current prices of products; a database agent configured to obtain product features.

Clause 9. The apparatus of any of clauses 1-8, wherein the orchestrator is configured to receive a query of whether a piece of software code in a pull request is compliant with a coded character set regulation and the agents include one or more of: an agent configured to identify a known compliance issue with the coded character set regulation; an agent configured to identify a known compliance issue outside of the coded character set regulation; an agent configured to identify a coded character display issue; or an agent configured to identify a coded character encoding issue.

Clause 10. The apparatus of any of clauses 1-9, wherein each agent is an artificial intelligence (AI) language agent configured to perform a task indicated in the description of the agent.

Clause 11. A method of answering a query with a plurality of artificial intelligence agents comprising: receiving the query from a client; applying the query to an orchestrator to select a subset of agents to answer the query, the orchestrator applying a relevance ranking algorithm to the query and an agent description set including a description of each agent and a description of a separator class having a description of context outside of a domain of the plurality of artificial intelligence agents; providing the query to each selected agent in the subset of agents; and aggregating responses from each selected agent; and output the aggregated response to the client.

Clause 12. The method of clause 11, wherein the orchestrator dynamically selects a number of the agents in the subset based on a ranking of the separator class within the plurality of artificial agents, wherein the separator class is associated with a description including examples that do not overlap with examples in the descriptions of the other agents in the agent description set.

Clause 13. The method of clause 11 or 12, wherein the relevance ranking algorithm is a low rank adaptation model comprising a base model and an arm corresponding to each agent.

Clause 14. The method of clause 13, further comprising adding an agent description for a new agent to the agent description set and adding an arm corresponding to the new agent to the low rank adaptation model without retraining the base model.

Clause 15. The method of any of clauses 11-14, wherein providing the query to each selected agent comprises applying the query and selected agents to a trained meta-learning decision tree model including a node for each agent.

Clause 16. The method of clause 15, wherein the trained meta-learning decision tree model is trained on user prompts, end-to-end responses, and models for agent-specific tasks to select an order to inference the selected subset of agents.

Clause 17. The method of any of clauses 11-16, wherein the orchestrator is configured to receive a query including contextual customer information and the agents include one or more of: a business intent agent configured to identify an intent of the query; a multi-turn message agent configured to collect the contextual customer information from multiple messages; a product recognition agent configured to identify products related to the query; a pricing agent configured to obtain current prices of products; a database agent configured to obtain product features.

Clause 18. The method of any of clauses 11-17, wherein the orchestrator is configured to receive a query of whether a piece of software code in a pull request is compliant with a coded character set regulation and the agents include one or more of: an agent configured to identify a known compliance issue with the coded character set regulation; an agent configured to identify a known compliance issue outside of the coded character set regulation; an agent configured to identify a coded character display issue; or an agent configured to identify a coded character encoding issue.

Clause 19. The method of any of clauses 11-18, wherein each agent is an artificial intelligence (AI) language agent configured to perform a task indicated in the description of the agent.

Clause 20. A non-transitory computer-readable medium storing computer-executable code that when executed by a processor causes the processor to: receive a query from a client; apply the query to an orchestrator to select a subset of agents to answer the query, the orchestrator applying a relevance ranking algorithm to the query and an agent description set including a description of each of a plurality of artificial intelligence agents and a description of a separator class having a description of context outside of a domain of the plurality of artificial intelligence agents; provide the query to each selected agent in the subset of agents; aggregate responses from each selected agent; and output the aggregated response to the client.

Clause 21. The non-transitory computer-readable medium of clause 20, wherein the computer-executable code, when executed by the processor, causes the processor to perform the method of any of clauses 12-19.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An apparatus for answering a query with a plurality of artificial intelligence agents, comprising:
one or more memories storing computer executable instructions; and
one or more processors configured to execute the instructions to cause the apparatus to:
receive the query from a client;
apply the query to an orchestrator to select a subset of agents to answer the query, the orchestrator applying a relevance ranking algorithm to the query and an agent description set including a description of each agent and a description of a separator class having a description of context outside of a domain of the plurality of artificial intelligence agents;
provide the query to each selected agent in the subset of agents;
aggregate responses from each selected agent; and
output the aggregated response to the client.

2. The apparatus of claim 1, wherein the orchestrator dynamically selects a number of the agents in the subset based on a ranking of the separator class within the plurality of artificial agents, wherein the separator class is associated with a description including examples that do not overlap with examples in the descriptions of other agents in the agent description set.

3. The apparatus of claim 1, wherein the relevance ranking algorithm is a low rank adaptation model comprising a base model and an arm corresponding to each agent.

4. The apparatus of claim 3, wherein the base model is configured to generate an embedding matrix of the query.

5. The apparatus of claim 3, wherein the one or more processors are configured to execute the instructions to add an agent description for a new agent to the agent description set and add an arm corresponding to the new agent to the low rank adaptation model without retraining the base model.

6. The apparatus of claim 1, wherein to provide the query to each selected agent, the one or more processors are configured to apply the query and selected agents to a trained meta-learning decision tree model including a node for each agent.

7. The apparatus of claim 6, wherein the trained meta-learning decision tree model is trained on user prompts, end-to-end responses, and models for agent-specific tasks to select an order to inference the selected subset of agents.

8. The apparatus of claim 1, wherein the orchestrator is configured to receive a query including contextual customer information and the agents include one or more of:
a business intent agent configured to identify an intent of the query;
a multi-turn message agent configured to collect the contextual customer information from multiple messages;
a product recognition agent configured to identify products related to the query;
a pricing agent configured to obtain current prices of products;
a database agent configured to obtain product features.

9. The apparatus of claim 1, wherein the orchestrator is configured to receive a query of whether a piece of software code in a pull request is compliant with a coded character set regulation and the agents include one or more of:
an agent configured to identify a known compliance issue with the coded character set regulation;
an agent configured to identify a known compliance issue outside of the coded character set regulation;
an agent configured to identify a coded character display issue; or
an agent configured to identify a coded character encoding issue.

10. The apparatus of claim 1, wherein each agent is an artificial intelligence (AI) language agent configured to perform a task indicated in the description of the agent.

11. A method of answering a query with a plurality of artificial intelligence agents comprising:
receiving the query from a client;
applying the query to an orchestrator to select a subset of agents to answer the query, the orchestrator applying a relevance ranking algorithm to the query and an agent description set including a description of each agent and a description of a separator class having a description of context outside of a domain of the plurality of artificial intelligence agents;
providing the query to each selected agent in the subset of agents; and
aggregating responses from each selected agent; and
output the aggregated response to the client.

12. The method of claim 11, wherein the orchestrator dynamically selects a number of the agents in the subset based on a ranking of the separator class within the plurality of artificial agents, wherein the separator class is associated with a description including examples that do not overlap with examples in the descriptions of other agents in the agent description set.

13. The method of claim 11, wherein the relevance ranking algorithm is a low rank adaptation model comprising a base model and an arm corresponding to each agent.

14. The method of claim 13, further comprising adding an agent description for a new agent to the agent description set and adding an arm corresponding to the new agent to the low rank adaptation model without retraining the base model.

15. The method of claim 11, wherein providing the query to each selected agent comprises applying the query and selected agents to a trained meta-learning decision tree model including a node for each agent.

16. The method of claim 15, wherein the trained meta-learning decision tree model is trained on user prompts, end-to-end responses, and models for agent-specific tasks to select an order to inference the selected subset of agents.

17. The method of claim 11, wherein the orchestrator is configured to receive a query including contextual customer information and the agents include one or more of:
a business intent agent configured to identify an intent of the query;
a multi-turn message agent configured to collect the contextual customer information from multiple messages;
a product recognition agent configured to identify products related to the query;
a pricing agent configured to obtain current prices of products;
a database agent configured to obtain product features.

18. The method of claim 11, wherein the orchestrator is configured to receive a query of whether a piece of software code in a pull request is compliant with a coded character set regulation and the agents include one or more of:
an agent configured to identify a known compliance issue with the coded character set regulation;
an agent configured to identify a known compliance issue outside of the coded character set regulation;
an agent configured to identify a coded character display issue; or
an agent configured to identify a coded character encoding issue.

19. The method of claim 11, wherein each agent is an artificial intelligence (AI) language agent configured to perform a task indicated in the description of the agent.

20. A non-transitory computer-readable medium storing computer-executable code that when executed by a processor causes the processor to:
receive a query from a client;
apply the query to an orchestrator to select a subset of agents to answer the query, the orchestrator applying a relevance ranking algorithm to the query and an agent description set including a description of each of a plurality of artificial intelligence agents and a description of a separator class having a description of context outside of a domain of the plurality of artificial intelligence agents;
provide the query to each selected agent in the subset of agents;
aggregate responses from each selected agent; and
output the aggregated response to the client.
